(19) United States
(12) Patent Application Publication
(10) Pub. No.: US 2021/0107766 A1
(43) Pub. Date: Apr. 15, 2021

(54) LIFT SYSTEM COMPRISING A PLURALITY OF LIFT CARS WHICH HAVE AN IDENTIFIER, AND METHOD FOR OPERATING A LIFT SYSTEM OF THIS KIND

(71) Applicants: thyssenkrupp Elevator AG, Essen (DE); thyssenkrupp AG, Essen (DE)

(72) Inventors: Richard THUM, Kornwestheim (DE); Marius MATZ, Filderstadt (DE); Eduard STEINHAUER, Nürtingen (DE)

(73) Assignees: thyssenkrupp Elevator AG, Essen (DE); thyssenkrupp AG, Essen (DE)

(21) Appl. No.: 16/496,717

(22) PCT Filed: Mar. 21, 2018
(86) PCT No.: PCT/EP2018/057086

§ 371 Date: Sep. 23, 2019

(30) Foreign Application Priority Data
Mar. 29, 2017 (DE) 10 2017 205 353.4

(51) Int. Cl. B66B 1/34; B66B 9/00; B66B 1/24; B66B 5/00

(52) U.S. Cl. CPC B66B 1/3461; B66B 9/003; B66B 2201/30; B66B 5/0018; B66B 5/0012; B66B 1/2433

(57) ABSTRACT

The present disclosure relates to a lift system including at least one lift shaft and a plurality of lift cars which can be individually moved. A plurality of the lift cars can be moved in the same lift shaft. The lift system further includes a control system for controlling the lift system. The lift cars of the lift system each have a unique identifier, for example an RFID transponder or a QR code. The disclosure further relates to a method for operating a lift system of this kind.

The present invention relates to an elevator system with at least one elevator shaft and a plurality of elevator cabs that can be moved individually. A plurality of elevator cabs can be moved within the same elevator shaft. Furthermore, such an elevator system comprises a control system for controlling the elevator system.

Such an elevator system assembly is known, for example, from WO 2015/144781 A1 or from EP 1 371 596 A1. In the case of such elevator systems, where a plurality of elevator cabs can be moved within the same elevator shaft, it is particularly important, in order to avoid collisions of elevator cabs, that it is known which elevator cab is located at which position in the shaft system formed from the elevator shafts.

EP 1 698 580 B1 discloses a shaft information system in the form of barcode carriers, with barcode symbols, extending along the entire travel path of an elevator shaft for determining the positions of elevator cabs, wherein barcode readers are arranged on the elevator cabs, which can detect the barcode symbols. Another shaft information system is known from EP 3 025 997 A1. This discloses the arrangement of position identifiers in an elevator shaft, which can be implemented by means of RFID transponders, wherein the elevator cabs comprise reader devices in order to be able to read the position identifiers.

A problem with such elevator systems is if an elevator cab is affected by a fault and cannot be moved during normal operation. EP 2 041 015 B1 discloses another elevator system with a plurality of elevator cabs which can be moved individually in a shaft system. In the case of this elevator system, the occurrence of a fault in the communication system is detected, which affects only one elevator cab. After this fault has been detected, a command is transmitted to the elevator cab affected by the fault, after which this elevator cab is parked outside of normal traffic routes of the remaining elevator cabs of the elevator system. The elevator system can then continue to be operated with the other elevator cabs. However, such an approach only works if the elevator cab affected by the fault can still be moved accordingly.

However, elevator cabs of an elevator system can also be affected by faults in such a way that further movement of the elevator cab is not possible, and the elevator cab must be retrieved by means of a support device. In particular, it can occur that, due to the fault, the reader device of the elevator cab cannot properly detect the position of the elevator cab or the detected position cannot be correctly transmitted to the control system of the elevator system. This at least hampers the determination of the elevator cab that should be retrieved by means of the support device. Furthermore, the region of the elevator shaft, in which the elevator cab affected by the fault is located, cannot be precisely detected, which impairs the further movement of the other elevator cabs.

Against this background, it is an object of the present invention to improve an elevator system with at least one elevator shaft and a plurality of elevator cabs that can be moved individually, in particular in the event of an elevator cab of the elevator system being affected by a fault and thus having to be retrieved.

In order to achieve this object, an elevator system and a method for operating this elevator system according to the independent claims are proposed. Other advantageous embodiments of the invention are described in the dependent claims and the description, and illustrated in the figures.

The proposed solution provides for an elevator system with at least one elevator shaft and a plurality of elevator cabs that can be moved individually, wherein a plurality of the elevator cabs can be moved in the same elevator shaft. In addition, the elevator system comprises a control system for controlling the elevator system, in particular for controlling the movement of the elevator cabs of the elevator system depending on issued calls. The elevator cabs of the elevator system each comprise a unique identifier. This means that an elevator cab of the elevator system can be advantageously uniquely identified using the identifier. Advantageously, the corresponding identifiers of the elevator cabs of the elevator system are stored in a memory unit of the control system. Advantageously, however, these identifiers are not specified by the control system of the elevator system, but directly connected to the elevator cab. If, for example, a communication fault occurs in such a way that the control system can no longer communicate with an elevator cab, advantageously, a unique identification of the elevator cab is made possible by reading the identifier of this elevator cab.

If the control system of the elevator system has detected a fault, for example with regard to a particular elevator cab of the elevator system, wherein the exact position of this elevator cab is not known to the control system due to the fault, advantageously, a support device introduced into an elevator shaft of the elevator system in order to retrieve this elevator cab can uniquely identify this elevator cab based on the identifier. It can thus be ensured in particular that the correct elevator cab is retrieved.

In accordance with a particularly advantageous embodiment, the proposed elevator system additionally comprises at least one reader device, which is designed to detect the identifiers of the elevator cabs. Furthermore, the at least one reader device is advantageously designed to identify an elevator cab of the elevator system by means of the detected identifier of this elevator cab, in particular to uniquely identify it. In particular, it is provided that the at least one reader device can be moved towards an elevator cab or into the proximity of an elevator cab so that the identifier of this elevator cab can be read. The transfer of the at least one reader device to an elevator cab of the elevator system can advantageously be controlled here by means of the control system of the elevator system.

A further advantageous embodiment provides that a unique identifier is assigned to each of the elevator cabs by means of the control system of the elevator system. The elevator cabs of the elevator system therefore advantageously each comprise an identifier and, in addition to this identifier, a unique identity assigned by the control system. Advantageously, the respective identifier or a corresponding carrier of the identifier is physically connected to the respective elevator cab in each case. The assigned identity, in turn, is advantageously stored and managed by the control system. In particular, it is provided that the identity of an elevator cab of the elevator system is assigned due to its position in the shaft system of the elevator system. In accordance with another advantageous embodiment, it is provided that the identities assigned to the elevator cabs by means of the control system are used for the communication of the elevator cabs with the control system. Advantageously, the control system is a decentralized control system, it being provided in particular that the elevator cabs each comprise their own control unit. By means of this control unit, data transfer between elevator cabs of the elevator system is advantageously also made possible.

In particular, it is provided that the identities assigned to the elevator cabs and the identifier of this elevator cab each form unique identification pairs, in particular in such a way that an identity can be uniquely assigned to at least one identifier. Advantageously, an identifier can furthermore also be uniquely assigned to an identity. If the case occurs, for example, that the control system can no longer communicate with a cab due to a fault, i.e. data exchange can no longer take place, in accordance with another advantageous aspect of the invention, it is provided that the control system can communicate the identifier of the affected elevator cab to a support device. By detecting the identifiers of the elevator cabs, it is advantageously made possible for the support device to identify the affected elevator cab and to retrieve the elevator cab identified in this manner.

In particular, it is provided that the elevator cabs of the elevator system comprise at least of the following elements as identifier: RFID transponder (RFID: radio-frequency identification), identification code, barcode, QR code, detection pattern. If the identifier is an RFID transponder, it is provided, in particular, that each of the elevator cabs of the elevator system comprises at least one RFID tag. If an elevator cab comprises a plurality of RFID tags, these are advantageously designed in such a way that the same identifier is provided when read. Alternatively or in addition, it is provided in particular that the elevator cabs of the elevator system comprise at least one barcode or at least one QR code, for example in the form of an accordingly printed sticker attached to the elevator cabs. Alternatively or in addition, it is provided in particular that the elevator cabs of the elevator system each comprise a readable memory unit, in which a unique identification code is stored so that, when reading the respective memory unit, an elevator cab of the elevator system can be uniquely identified by means of the identification code as identifier. Preferably, the readable memory unit is a read-only memory, also referred to as ROM.

Advantageously, the elevator cabs of the elevator system comprise the identifiers multiple times, in particular at the respective sides of an elevator cab, which is capable of being approached by a support device. If the elevator cabs are only moved upwards and downwards in a vertical elevator shaft, it is provided in particular that the elevator cabs each comprise the identifier on the cab roof and on the cab floor. If the elevator cabs can be furthermore moved laterally, in particular in at least one horizontal elevator shaft of the elevator system, it is provided in particular that the elevator cabs additionally each comprise the identifier on the corresponding side walls of the elevator cabs, which face the shaft.

The at least one reader device of the elevator system is designed according to the embodiment of the identifiers of the elevator cabs. Accordingly, in particular, it is provided that the at least one reader device may be at least one of the following reader devices: RFID reader, barcode scanner, QR code scanner, camera, microcontroller circuit with corresponding interface for reading a readable data store.

In accordance with another advantageous embodiment, the proposed elevator system comprises at least one support means for retrieving an elevator cab of the elevator system, wherein the at least one support means comprises the at least one reader device. In particular, it is provided that the support means is a support device for retrieving an elevator cab of the elevator system. In particular, it is provided that the at least one support means can be moved in the at least one elevator shaft, in particular to an elevator cab to be retrieved. In particular, it is provided as an embodiment that at least one of the elevator cabs of the elevator system is designed as a support means for retrieving an elevator cab affected by a fault. In accordance with another embodiment, a winch provided with a towing device, in particular a hook, is provided as support means, wherein the towing device preferably comprises a reader device. As a further design alternative, it is provided that the elevator system comprises at least one flying drone, wherein the at least one flying drone comprises the at least one reader device.

In accordance with another advantageous embodiment, the proposed elevator system comprises at least one storage facility for storing elevator cabs of the elevator system. Furthermore, the elevator system advantageously comprises at least one selection device for introducing elevator cabs of the elevator system into the storage facility of the elevator system and for moving elevator cabs of the elevator system out of the storage facility of the elevator system. The at least one selection device advantageously comprises the at least one reader device. This means that, by means of the at least one selection device, in order to increase the transport capacity, for example in the morning or at noontime, in particular elevator cabs can be introduced into the at least one elevator shaft of the elevator system to transport people and, in the case of reduced transport demand, elevator cabs can be moved out of the at least one elevator shaft by means of the at least one selection device. Thereby, by means of the reader device of the selection device, it can advantageously be detected which elevator cabs are located in the storage facility and which elevator cabs are located within the at least one elevator shaft. In addition, elevator cabs to be retrieved can be moved into the storage facility, in particular, so that these can then be repaired.

As another advantageous embodiment, it is provided that at least one first elevator cab of the elevator system comprises first characteristics and at least one second elevator cab of the elevator system comprises second characteristics, wherein, by means of the respective identifier of an elevator cab, the characteristics of said elevator cab can be determined. Characteristics of the elevator cabs thereby relate in particular to equipment of the elevator cabs. Thus, first elevator cabs and second elevator cabs can differ, in particular, in terms of the equipment for transporting disabled persons. Furthermore, it is provided that first elevator cabs and second elevator cabs differ with regard to the cab design. In particular, advantageously elevator cabs, in particular VIP elevator cabs, are provided with a particularly high-quality design for the transport of VIPs. Advantageously, the respective identifier of an elevator cab allows its characteristics to be detected.

Advantageously, the elevator system takes a specification of characteristics of an elevator cab into account in the case of a transport request, wherein certain specifications of characteristics are linked to certain identifiers of the elevator cabs. If, for example, a person to be transported identifies himself as a VIP at a call input device, it is provided in particular that a VIP elevator cab is assigned to this person. Using the identifiers of the elevator cabs, the control system of the elevator system advantageously assigns the VIP elevator cab in such a way that said cab is moved to the corresponding floor for which the elevator cab was requested.

Another advantageous embodiment of the proposed elevator system provides that the elevator cabs each comprise a monitoring unit, which is designed to perform a self-diagnosis with regard to the functionality of elements of the related elevator cab, wherein, advantageously, the monitoring unit provides the identifier of the elevator cab. In particular, it is provided that the monitoring unit is designed to detect at least one of the following problems: a problem when sending and/or receiving data; problems with a brake of the elevator cab; problems with the energy supply of an elevator cab, problems when opening and/or closing the doors of the elevator cab. Advantageously, a support device for retrieving such an elevator cab affected by a fault detects not only the identifier of the elevator cab, which can, in particular, be stored in a read-only memory of the monitoring unit, but additionally the result of the self-diagnosis so that the support device can provide appropriate assistance, in particular a communication link for sending and/or receiving data and/or an energy supply for the elevator cab.

In accordance with a further advantageous embodiment, the element providing the identifier of the respective elevator cab of the elevator system provides additional user data. The element providing the identifier is, in particular, an RFID transponder, a barcode, a QR code or a readable data store. The other user data can advantageously relate to characteristics of the respective elevator cabs.

Advantageously, the user data comprise a checksum, wherein a correct detection of the identifier of an elevator cab of the elevator system can be determined by means of the checksum. In this way, it can be furthermore determined in an improved manner that an elevator cab can be correctly identified, in particular an elevator cab to be retrieved.

Another advantageous embodiment provides that the elevator cabs each comprise at least one reader device for detecting the identifier of other elevator cabs of the elevator system. This advantageously enables elevator cabs of the elevator system to uniquely identify each other. A normally functioning elevator cab can, for example, identify an elevator cab affected by a fault and communicate the position of this elevator cab to the control system. Advantageously, the control system is designed to move the other elevator cabs, wherein the control system and the elevator cab affected by the fault determines a region, into which the other elevator cabs are not allowed to be moved. Furthermore, the control system is advantageously designed to transfer a support device for retrieving the elevator cab affected by the fault to this elevator cab.

The method furthermore proposed for operating an above-described elevator system for achieving the above-mentioned object provides for the identifier of an elevator cab of the elevator system to be detected in order to identify this elevator cab. This advantageously allows an elevator cab to be uniquely identified, in particular to an elevator cab affected by a fault. Furthermore, other advantageous applications for the identification of elevator cabs are provided, in particular for determining elevator cabs of the elevator system which comprise special equipment for transporting disabled persons or for determining and assigning VIP elevator cabs. Another advantageous application is the introduction of elevator cabs into and the moving of elevator cabs out of a storage facility of the elevator system, in particular for adapting the elevator system to changing transport demand.

In particular, it is provided that, by means of a support device, an elevator cab of the elevator system is retrieved, wherein the elevator cab to be retrieved is identified by detecting the identifier of this elevator cab.

Further advantageous details, features and embodiment details of the invention will be explained in more detail in conjunction with the exemplary embodiments illustrated in the figures, in which:

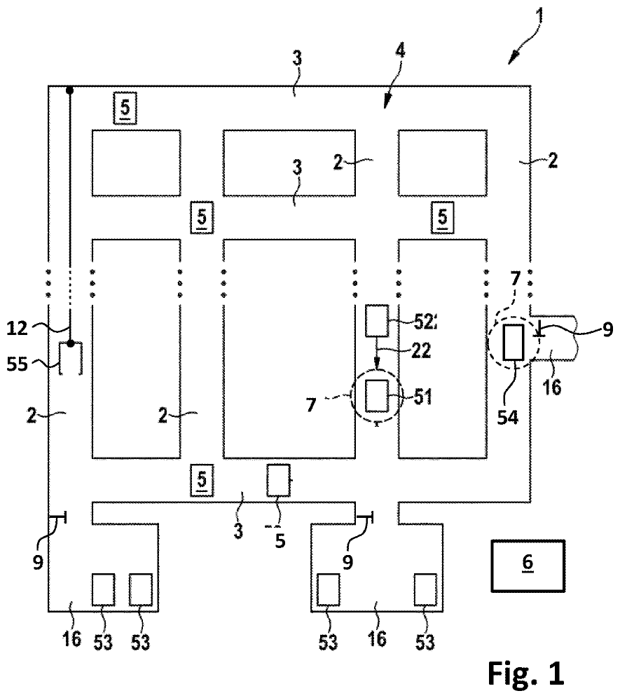

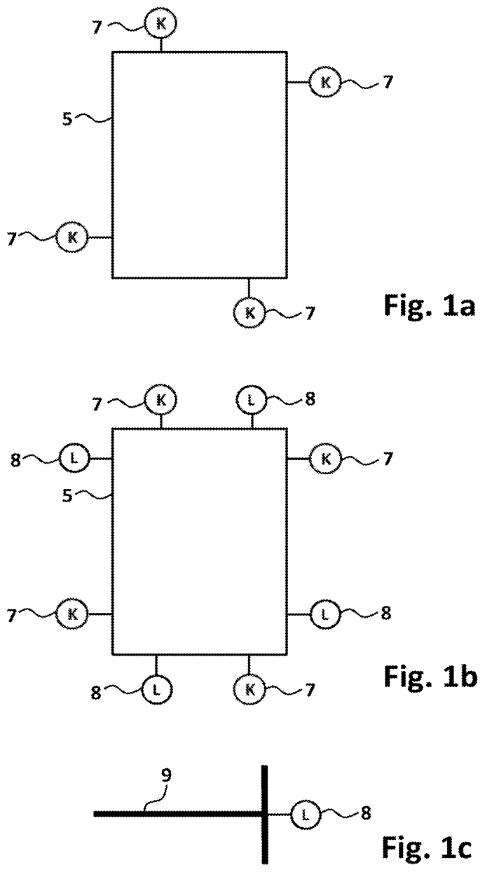

FIG. 1 shows, in a simplified schematic illustration, an exemplary embodiment for an elevator system designed according to the invention.

FIG. 1a shows, in a simplified schematic illustration, an exemplary embodiment for an elevator cab of the elevator system shown in FIG. 1;

FIG. 1b shows, in a simplified schematic illustration, another exemplary embodiment for an elevator cab of the elevator system shown in FIG. 1;

FIG. 1c shows, in a simplified schematic illustration, an exemplary embodiment for a selection device of the elevator system shown in FIG. 1; and

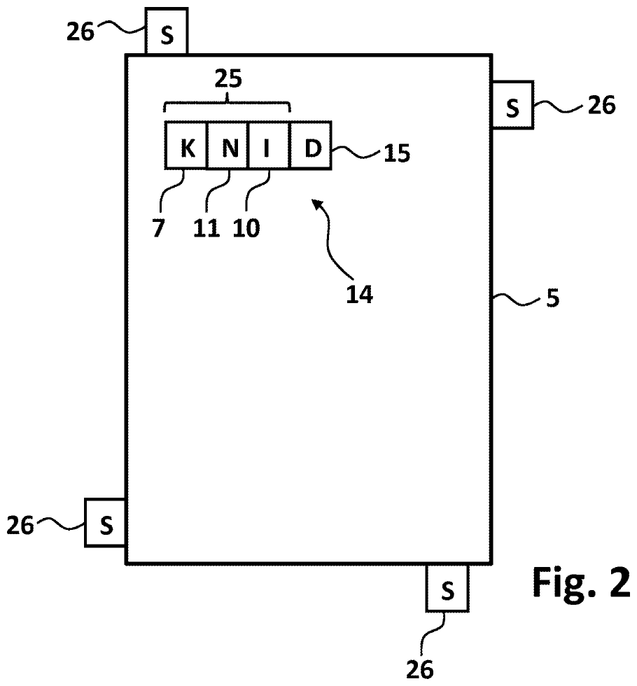

FIG. 2 shows, in a simplified schematic illustration, another exemplary embodiment for an elevator cab of the elevator system shown in FIG. 1,

The elevator system 1, shown in FIG. 1 by way of example, comprises a shaft system 4 with a plurality of vertical elevator shafts 2 and a plurality of horizontal elevator shafts 3. In addition, the elevator system 1 comprises a plurality of elevator cabs 5. These elevator cabs 5 can be moved individually in the elevator shafts 2, 3 of the elevator system 1. In particular, a plurality of elevator cabs 5 can also be moved in the same vertical elevator shaft 2 or in the same horizontal elevator shaft 3. Preferably, for this purpose, the elevator system comprises a linear motor drive (not explicitly shown in FIG. 1), by means of which the elevator cabs 5 can be moved taking into account specified operating conditions largely independently of one another. In order to change from one elevator shaft into another elevator shaft, for example from a vertical elevator shaft 2 into a horizontal elevator shaft 3, the elevator system 1 comprises shaft changing units (not explicitly shown in FIG. 1). If the elevator system 1 comprises a linear motor drive as drive system, it is provided in particular that the shaft changing units are rotatable or pivotable sections of the linear motor drive, so-called exchanger units. If an elevator cab 5 of the elevator system 1 is moved vertically and is to change into a horizontal elevator shaft 3, the exchanger unit is accordingly rotated by 90° if this elevator cab is located in the exchanger unit. Such exchanger units are described in more detail for example in WO 2015/144781 A1.

The elevator system 1 comprises a control system 6 for moving the elevator cabs 5 of the elevator system 1. This is only symbolically shown in FIG. 1. In particular, it is provided that the control system 6 is a decentralized control system with a plurality of control units, in which the control units are linked to one another (not shown in FIG. 1) and can exchange data with one another. In this way, in accordance with an embodiment variant, it is provided that, in particular, the elevator cabs 5 and the shaft changing units each comprise their own control units. The control system 6 can, in particular, also comprise safety units, which, in particular, prevent collisions of elevator cabs 5 by monitoring the adherence to minimum distances between the elevator cabs 5, for example. For this purpose, it is advantageously furthermore provided that the elevator system 1 comprises a shaft information system (not explicitly shown in FIG. 1), which is designed in particular to communicate positions and speeds of elevator cabs 5 to the control system 6.

In order to detect calls by elevator users, it is provided in particular that the elevator system 1 includes a target call control system (not explicitly shown in FIG. 1). In particular, the elevator system 1 can also comprise a control system with the input of external calls at least in regions of the elevator system, in particular if, in at least one shaft region of the shaft system 4, operation of the elevator system 1 as a shuttle system for transporting persons between an access floor, in particular the ground floor, to a transfer floor is provided.

The elevator system 1 also comprises storage facilities 16, in which elevator cabs 5 of the elevator system can be parked, in particular if current traffic does not require the maximum conveying capacity of the elevator system 1 or if elevator cabs need to be serviced or repaired. By way of example, parked elevator cabs 53 are shown in the storage facilities 16 of the elevator system 1.

The elevator cabs 5 of the elevator system 1 each comprise a unique identifier 7. Since each elevator cab 5 of the elevator system 1 comprises a unique identifier 7, an elevator cab 5 can be uniquely identified by means of the identifier 7. In particular, an RFID transponder is provided as identifier 7, preferably a passive RFID transponder. As advantageous alternative embodiments, in particular QR codes or barcodes are provided as identifier 7. The elevator cabs 5 preferably comprise this identifier 7 multiple times, as is schematically shown in FIG. 1a. This has the advantage that the identifier 7 can be detected when approaching an elevator cab 5 of the elevator system 1 from any direction. By detecting the identifier 7, it can advantageously be exactly determined which elevator cab 5 of the elevator system 1 it is.

The elevator system 1 advantageously comprises a plurality of reader devices 8 for detecting the identifiers 7 of the elevator cabs 5. These reader devices 8 are designed to detect the identifiers 7 of the elevator cabs 5. If the identifiers 7 are RFID transponders, in particular RFID tags attached to the elevator cabs 5, the reader devices 8 of the elevator system 1, in particular, each comprise a so-called RFID reader, by means of which the respective identifier can be read from the RFID transponders. Furthermore, the reader devices 8 of the elevator system 1 are designed to identify the corresponding elevator cab 5 of the elevator system by means of the detected identifier 7. In order to identify the elevator cab 5, it is provided in particular that the reader devices 8 can exchange data with the control system 6 of the elevator system 1. In particular the identifier 7 of an elevator cab 5 detected by a reader device 8 of the elevator system 1 can be sent from the reader device 8 to the control system 6.

In the case of the exemplary embodiment of an elevator system 1 shown in FIG. 1, it is provided that at least some of the elevator cabs 5 of the elevator system 1, in particular all elevator cabs 5 of the elevator system 1, comprise a reader device 8. As is shown in FIG. 1b by way of example, it can be provided in particular that the elevator cabs 5 comprise a reader device 8 on the sides that point in a shaft direction in the case of vertical travel or horizontal travel. Such an embodiment is, in particular, provided if the identifier 7 of an elevator cab can only be read from a short distance, for example a distance of less than two meters. Even if a line of sight is required, as is the case with the use of barcodes or QR codes as identifier 7 of the elevator cabs, such an embodiment is advantageous. If, in contrast, an RFID transponder, in particular an active RFID transponder, is used as identifier, it is provided in particular that an elevator cab 5 of the elevator system 1 comprises only one reader device 8.

Elevator cabs 5, comprising a reader device 8, of the elevator system 1 are therefore advantageously designed to uniquely identify other elevator cabs 5 of the elevator system 1. This is particularly advantageous if an elevator cab 51 is affected by a fault in such a way that the exact position of this elevator cab 51 cannot be determined. A further elevator cab 52 can then advantageously be moved in the direction of the last known position of the elevator cab 51 affected by the fault. In the case of an activated reader device 8, this other elevator cab 52 then continues to move until a detection 22 of the identifier 7 of the elevator cab 51 affected by the fault takes place. The elevator cab 52 can advantageously communicate to the control system 6 its own position when detecting 22 the identifier 7 of the elevator cab 51 affected by the fault so that the position of this elevator cab 51 can be determined in an improved manner.

In accordance with an advantageous embodiment variant, it can also be provided that the elevator cab 51 affected by the fault can be retrieved by means of another elevator cab 52 as support device. For this purpose, the elevator cab operating as support device can tow the elevator cab 51 affected by the fault, in particular, into a storage facility 16 of the elevator system.

In the case of the elevator system 1 shown in FIG. 1, it is provided in particular that support devices 12 are installed in the shaft system 4 of the elevator system 1, in particular on towing devices arranged on winches, such as towing hooks for example. For example, if the control system 6 of the elevator system 1 registers a communication fault with regard to the communication with an elevator cab 55 of the elevator system 1 such that this elevator cab 55 cannot be moved further and the exact position of this elevator cab 55 is not known, the control device 6 can provide for retrieval of this elevator cab 55 by means of the support device 12. The support device 12, in particular the towing device, is moved to the last known position of the elevator cab 55, meaning, i.e. introduced in particular into the elevator shaft in which the elevator cab 55 was last located. It is provided that the towing device likewise comprises a reader device (not explicitly shown in FIG. 1). By means of this reader device, the identifier 7 of the elevator cab 55 is read. It can thus be advantageously ensured that the correct elevator cab 55 is retrieved by the support device 12. If it was determined by the support device 12 from reading the identifier 7 that this is an elevator cab other than the faulty elevator cab, this other elevator cab can initially be moved to another position, and then a new retrieval attempt can be started.

When reading the identifier 7, advantageously, in addition, a checksum is also transmitted by the corresponding carrier of the identifier 7, for example by the RFID tag, so that it can be verified using the checksum that the actual identifier 7 has been correctly transmitted.

In the elevator system 1 shown in FIG. 1, it is provided additionally that the elevator system 1 comprises selection devices 9. By means of these selection devices 9, elevator cabs 5 can be moved from the elevator shafts 2, 3 into the storage facilities 16. Therefore, the conveying capacity of the elevator system 1 can advantageously be changed and adapted to an existing and/or projected transport requirement.

The selection devices 9 advantageously comprise at least one reader device 8, as is schematically shown in FIG. 1c. By means of this reader device 8, the identifiers 7 of elevator cabs 5 are read. Advantageously, this allows it to be ensured that the correct elevator cabs 5 are moved into a storage facility 16 or moved out of a storage facility 16.

In particular, it is provided that elevator cabs 5 of the elevator system 1 comprise different characteristics. In particular, the elevator system 1 can comprise a limited number of elevator cabs, which are specially equipped for transporting visually impaired persons, preferably with a voice control system. Furthermore, another number of elevator cabs 5 can be particularly luxuriously equipped. Here, the identifiers 7 of the elevator cabs 5 are advantageously linked to the characteristics of the elevator cabs 5 so that the information concerning which elevator cabs 5 with which identifier 7 comprise which characteristics is stored in particular in the control system 6.

If, for example, a visually impaired person identifies himself/herself when inputting the call, using in particular a means of identification, for example an ID card, the control system 6 of the elevator system 1 reports a need for an elevator cab 5 equipped for transporting visually impaired persons. The selection device 9 can then determine an elevator cab 54 with these corresponding characteristics by reading the identifiers 7 of elevator cabs 53 parked in the storage facilities 16 and move it out of the storage facility 16 so that it can then be used to service the call for the visually impaired person.

In particular, it is provided that the identifier 7 of an elevator cab 5 is communicated to the control system 6 when moving an elevator cab 53 out of a storage facility 16 by the corresponding selection device 9. The control system 6 for its part assigns a unique identity to this elevator cab, which is used, in particular, for the exchange of data with this elevator cab. The identity assigned to an elevator cab by the control system 6 and the identifier 7, which each elevator cab 5 comprises, respectively form a unique identification pair. The control system 6 to which an identifier 7 is communicated can uniquely identify in particular the elevator cab 5 that comprises this identifier 7, advantageously even if communication with this elevator cab might be disrupted.

Another advantageous embodiment of an elevator cab 5 of an elevator system 1 is shown in FIG. 2. It is provided here that the elevator cabs 5 each comprise a monitoring unit 14. Such a monitoring unit 14 is advantageously designed to perform a self-diagnosis with regard to the functionality of elements of the related elevator cab 5, for example of the communication module, of the doors, of the brakes, or of the energy supply system. For this purpose, the monitoring unit 14 advantageously comprises a diagnostic unit 15. Furthermore, it is provided that the monitoring unit 14 comprises in particular a plurality of memory areas 25. The monitoring unit 14 provides the identifier 7 of the respective elevator cab 5 in a memory area. This can be read via interfaces 26, which are arranged on the exterior of the elevator cab 5, in particular by a support device for retrieving the elevator cab 5. Via the interfaces 26, further data can also be transmitted, in particular a checksum by means of which it can be determined by the unit detecting the identifier 7 if the identifier 7 has been transmitted correctly. Advantageously, other user data 11 can be transmitted via the interfaces 26. These user data 11 are also stored in a memory area 25 of the monitoring unit 14. In addition to the checksum, the user data can include the result of the self-diagnosis, for example as an error log of the respective elevator cab 5.

Furthermore, in the memory area 25, an identity 10 assigned by the control system 6 of the elevator system 1 of the elevator cab 5 can be stored. Advantageously, in contrast to the identifier, this identity can be changed by the control system 6. The identity 10 can also only be assigned temporarily. The identifier 7 is, by contrast, permanently assigned to an elevator cab 5. The identity 10 assigned to an elevator cab 5 and the identifier 7 of this elevator cab 5 thereby form unique identification pairs. The identifiers 7 of the elevator cabs 5 are advantageously also known to the control system 6 here. If, by means of a reader device, the identifier 7 of the elevator cab 5 is detected and this identifier 7 is communicated to the control system 6, the control system 6 can advantageously assign an identity to this identifier 7 and thus determine if the elevator cab 5, the identifier 7 of which has been detected and transmitted to the control system 6, is an elevator cab affected by a fault.

The exemplary embodiments illustrated in the figures and explained in conjunction therewith serve to explain the invention and do not limit the invention. In particular, the figures are not true to scale.

### LIST OF REFERENCE SIGNS

1 elevator system
2 vertical elevator shaft
3 horizontal elevator shaft
4 shaft system
5 elevator cab
51 elevator cab to be retrieved
52 other elevator cab
53 parked elevator cab
54 other elevator cab
55 other elevator cab to be retrieved
6 control system
7 identifier
8 reader device
9 selection device
10 identity
11 user data
12 support means
14 monitoring unit
15 diagnostics unit
16 storage facility
22 detection of an identifier
25 memory area
26 interface

1.-16. (canceled)

17. An elevator system, comprising:
an elevator shaft,
a plurality of elevator cabs configured to move individually in the same elevator shaft, and
a control system configured to control the elevator system,
wherein each of the elevator cabs each comprise a unique identifier.

18. The elevator system of claim 17, comprising a reader device, configured to detect the identifiers of the elevator cabs and/or to identify an elevator cab of the elevator system via the detected identifier.

19. The elevator system of claim 18, wherein the control system is configured to assign a unique identity to each of the elevator cabs.

20. The elevator system of claim 19, wherein the identities assigned to the elevator cabs and the identifiers of these elevator cabs each form unique identification pairs.

21. The elevator system of claim 17, wherein the elevator cabs comprise at least one of the following elements as identifier: a RFID transponder, an identification code, a barcode, a QR code, or a detection pattern.

22. The elevator system of claim 17, comprising a support means for retrieving an elevator cab of the elevator system, wherein the support means comprises the reader device.

23. The elevator system of claim 17, comprising at least one storage facility configured to store elevator cabs of the elevator system and a selection device configured to introduce elevator cabs into the storage facility of the elevator system and configured to move elevator cabs out of the storage facility, wherein the selection device comprises the reader device.

24. The elevator system of claim 17, wherein a first elevator cab of the elevator system comprises first characteristics and a second elevator cab of the elevator system comprises second characteristics, wherein, via the identifier of one of the first and second elevator cab, the characteristics of said elevator cab can be determined.

25. The elevator system of claim 24, wherein the elevator system takes a specification of characteristics of an elevator cab into account in the case of a transport request, wherein certain specifications of characteristics are linked to certain identifiers of the elevator cabs.

26. The elevator system of claim 17, wherein the elevator cabs each comprise a monitoring unit, which is configured to perform a self-diagnosis with regard to the functionality of elements of the corresponding elevator cab, wherein the monitoring unit provides the identifier of the elevator cab.

27. The elevator system of claim 17, wherein the element providing the identifier of a respective elevator cab of the elevator system provides additional user data.

28. The elevator system of claim 27, wherein the additional user data comprises a checksum, wherein a correct detection of the identifier of the respective elevator cab of the elevator system can be determined by means of the checksum.

29. The elevator system of claim 17, wherein the elevator cabs comprise the identifier multiple times.

30. The elevator system of claim 17, wherein the each of the elevator cabs comprises a reader device for detecting the identifier of other of the elevator cabs of the elevator system.

31. A method for operating an elevator system, having an elevator shaft,
a plurality of elevator cabs configured to move individually in the same elevator shaft, and
a control system configured to control the elevator system, wherein each of the elevator cabs each comprise a unique identifier, the method comprising:
detecting the identifier of an elevator cab of the elevator system, and
identifying the elevator cab.

32. The method as claimed in claim 31, wherein, via a support means, an elevator cab of the elevator system is retrieved, wherein the elevator cab to be retrieved is identified by detecting the identifier of the corresponding elevator cab.
